(19) United States
(12) Patent Application Publication
(10) Pub. No.: US 2026/0331365 A1
(43) Pub. Date: Oct. 22, 2026

(54) POWDER MAGNETIC CORE, INDUCTOR, AND METHOD FOR MANUFACTURING POWDER MAGNETIC CORE

(71) Applicant: TOKIN Corporation, Shiroishi-shi (JP)

(72) Inventors: Shun MIKOSHIBA, Shiroishi-shi (JP); Hiroshi SHIMA, Shiroishi-shi (JP); Makoto YAMAKI, Shiroishi-shi (JP); Naoto ONISHI, Shiroishi-shi (JP); Kenichiro KOBAYASHI, Shiroishi-shi (JP); Akiri URATA, Shiroishi-shi (JP)

(21) Appl. No.: 19/730,165

(22) Filed: Jul. 2, 2026

Related U.S. Application Data
(62) Division of application No. 17/648,502, filed on Jan. 20, 2022.

(30) Foreign Application Priority Data
Mar. 10, 2021 (JP) 2021-038421

(51) Int. Cl. H01F 41/02; H01F 1/26; H01F 3/08; H01F 27/255

(52) U.S. Cl. CPC H01F 41/0246; H01F 1/26; H01F 3/08; H01F 27/255; Y10T 428/32

(57) ABSTRACT

A powder magnetic core capable of achieving a low loss in a high frequency range while reducing the size thereof is provided. A powder magnetic core according to the present disclosure is a powder magnetic core in which a magnetic powder is bonded via a binder layer. The powder magnetic core contains 88 volume % or more of magnetic powder, and the percentage of parts of the binder layer having thicknesses of 20 nm or smaller in the binder layer that is present between particles of the magnetic powder is equal to or smaller than 6% (not including 0%).

### CROSS-REFERENCE TO RELATED APPLICATIONS

The present application is a divisional of U.S. Non-Provisional patent application Ser. No. 17/648,502, entitled “POWDER MAGNETIC CORE, INDUCTOR, AND METHOD FOR MANUFACTURING POWDER MAGNETIC CORE”, and filed on Jan. 20, 2022. U.S. Non-Provisional patent application Ser. No. 17/648,502 claims priority to Japanese Patent Application No. 2021-038421, filed on Mar. 10, 2021. The entire contents of the above-listed applications are hereby incorporated by reference for all purposes.

### BACKGROUND

The present disclosure relates to a powder magnetic core, an inductor, and a method for manufacturing a powder magnetic core.

In recent years, inductors have been used in a variety of electronic devices. Inductors used in electronic devices such as personal computers, in particular, are required to be small in size and to exhibit high inductance characteristics even when a large current is made to flow through the inductors. Japanese Unexamined Patent Application Publication No. H10-212503 discloses a method for manufacturing a pressed powder body of amorphous magnetically soft alloy having less diminished in magnetic permeability in a high frequency range.

### SUMMARY

As described above, it is required that inductors have a small size and exhibit high inductance characteristics even when a large current is made to flow through the inductors. In particular, since inductors that are used in electronic devices such as personal computers are used in a high frequency range (e.g., 750 kHz-2 MHz), an inductor having a low loss in a high frequency range is required.

In view of the aforementioned problem, the present disclosure aims to provide a powder magnetic core, an inductor, and a method for manufacturing a powder magnetic core capable of achieving a low loss in a high frequency range while reducing the respective sizes of the powder magnetic core and the inductor.

A powder magnetic core according to one aspect of the present disclosure is a powder magnetic core in which a magnetic powder is bonded via a binder layer, in which the powder magnetic core contains 88 volume % or more of magnetic powder, and the percentage of parts of the binder layer having thicknesses of 20 nm or smaller in the binder layer that is present between particles of the magnetic powder is equal to or smaller than 6% (not including 0%).

A method for manufacturing a powder magnetic core according to one aspect of the present disclosure includes: a process of coating a magnetic powder with a low melting glass; a process of coating the magnetic powder coated with the low melting glass with a resin material for granulation; and a process of hot forming the magnetic powder after the granulation. The formed body after the hot forming contains 88 volume % or more of magnetic powder, a binder layer including the low melting glass and the resin material is formed between particles of the magnetic powder, and the percentage of parts of the binder layer having thicknesses of 20 nm or smaller in the binder layer that is present between particles of the magnetic powder is set to be equal to or smaller than 6% (not including 0%).

According to the present disclosure, it is possible to provide a powder magnetic core, an inductor, and a method for manufacturing a powder magnetic core capable of achieving a low loss in a high frequency range while reducing the respective sizes of the powder magnetic core and the inductor.

The above and other objects or features of the present disclosure will become more fully understood from the detailed description given hereinbelow and the accompanying drawings which are given by way of illustration only, and thus are not to be considered as limiting the present disclosure.

### BRIEF DESCRIPTION OF THE FIGURES

FIG. 1 is a perspective view showing one example of an inductor according to an embodiment;

FIG. 2 shows electron micrographs of a powder magnetic core according to related art and a powder magnetic core according to the present disclosure;

FIG. 3 is a schematic view for describing a microstructure of the powder magnetic core according to related art and a microstructure of the powder magnetic core according to the present disclosure;

FIG. 4 shows electron micrographs showing a microstructure of a powder magnetic core according to the embodiment;

FIG. 5 is a flowchart for describing a method for manufacturing the powder magnetic core according to the embodiment;

FIG. 6 is a schematic view for describing the method for manufacturing the powder magnetic core according to the embodiment;

FIG. 7 is a horizontal cross-sectional view of a powder magnetic core according to the embodiment;

FIG. 8 is a horizontal cross-sectional view of the powder magnetic core according to the embodiment;

FIG. 9 is a horizontal cross-sectional view of the powder magnetic core according to the embodiment;

FIG. 10 is a horizontal cross-sectional view of the powder magnetic core according to the embodiment; and

FIG. 11 is a graph in which an iron loss of samples and the percentage of binder layers of 20 nm or smaller are plotted when the amount of a binder and the particle size of a magnetic powder are made the same.

### DETAILED DESCRIPTION

### Inductor

Hereinafter, with reference to the drawings, an embodiment of the present disclosure will be described.

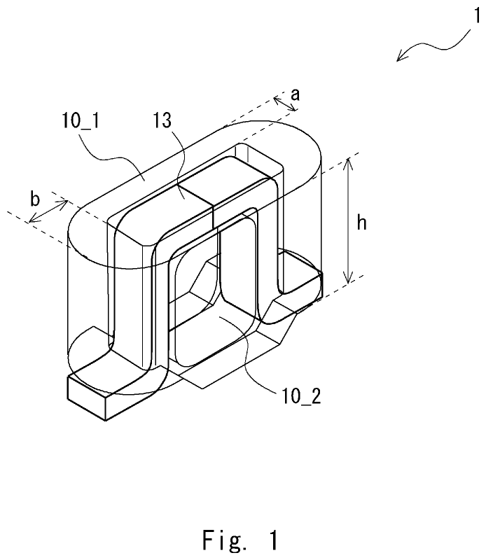

FIG. 1 is a perspective view showing one example of an inductor according to this embodiment. As shown in FIG. 1, an inductor 1 according to this embodiment includes powder magnetic cores 10_1 and 10_2, and a coil 13. The powder magnetic core 10_1, which includes a cavity penetrating the center thereof in the vertical direction, is disposed so as to surround the outer side of the coil 13. The powder magnetic core 10_2, which is provided inside the coil 13, is disposed in a recessed part of the coil 13 having a U-shaped cross section.

For example, the inductor 1 shown in FIG. 1 is formed by arranging the powder magnetic core 10_2 in the recessed part of the coil 13 and press-fitting the powder magnetic core 10_1 from above. Accordingly, the inductor 1 including the coil 13 surrounded by the powder magnetic cores 10_1 and 10_2 can be formed. The powder magnetic cores 10_1 and 10_2 may also be collectively referred to as a powder magnetic core 10 in this description. Further, the structure of the inductor 1 shown in FIG. 1 is merely one example and the powder magnetic core 10 according to this embodiment may be used for an inductor including a structure other than that shown in FIG. 1. The powder magnetic core according to this embodiment achieves a low loss in a high frequency range while the size thereof is reduced. Hereinafter, the powder magnetic core according to this embodiment will be described in detail.

### Powder Magnetic Core

The powder magnetic core according to this embodiment is a powder magnetic core in which a magnetic powder is bonded via a binder layer. The powder magnetic core contains 88 volume % or more of magnetic powder and the percentage of parts of the binder layer having thicknesses of 20 nm or smaller in the binder layer that is present between particles of the magnetic powder is equal to or smaller than 6% (not including 0%). With the above structure, it is possible to provide a powder magnetic core capable of achieving a low loss in a high frequency range while reducing the size thereof. The percentage of parts of the binder layer having thicknesses of 20 nm or smaller in the binder layer that is present between particles of the magnetic powder may be equal to or smaller than 3.3%.

The magnetic powder used for the powder magnetic core according to this embodiment is a soft magnetic powder containing an iron element. For example, the particle size of the magnetic powder is equal to or larger than 2 μm but equal to or smaller than 25 μm, or for instance, equal to or larger than 5 μm but equal to or smaller than 15 μm. In the present disclosure, the particle size is a median diameter D50. This is a value measured by using a laser diffraction-scattering method.

In this embodiment, a metallic glass may be used as the magnetic powder. The metallic glass may be, for example, an amorphous metallic glass prepared by an atomizing method. It may be, for example, an Fe—P—B alloy, an Fe—B—P—Nb—Cr alloy, an Fe—Si—B alloy, an Fe—Si—B—P alloy, an Fe—Si—B—P—Cr alloy, or an Fe—Si—B—P—C alloy. By powdering them by an atomizing method, the metallic glass having a glass transition point can be formed. In the present disclosure, in particular, an Fe—B—P—Nb—Cr-based material can be used. The metallic glass obtained by the atomizing method is not limited thereto and may be a metallic glass that does not have a glass transition point.

Further, in this embodiment, a nanocrystallized powder may be, for example, used as the magnetic powder. For example, the nanocrystallized powder may be the one prepared by an atomizing method. For example, by powdering an Fe—Si—B—P—C—Cu-based material, an Fe—Si—B—Cu—Cr-based material, an Fe—Si—B—P—Cu—Cr-based material, an Fe—B—P—C—Cu-based material, an Fe—Si—B—P—Cu-based material, an Fe—B—P—Cu-based material, or an Fe—Si—B—Nb—Cu-based material by using the atomizing method, a nanocrystallized powder including at least two exothermic peaks indicating crystallization in the heat treatment process of the magnetic powder can be formed. The nanocrystallized powder to be used, which is not particularly limited, may be, for example, an Fe—Si—B—P—Cu—Cr-based material.

In this embodiment, the closer the shape of particles of the magnetic powder is to spherical, the better. When the sphericity of the particles is low, protrusions are formed on the surface of the particles. When a molding pressure is applied, stress from surrounding particles concentrates on the protrusions, causing the coating to break and a sufficiently high insulation cannot be maintained, which may result in deterioration of the magnetic properties (in particular, loss) of the resulting powder magnetic core. The sphericity of the particles may be controlled within a suitable range by adjusting manufacturing conditions of the magnetic powder such as a water volume and a water pressure of high-pressure water jet used for atomization if a water atomizing method is employed, the temperature and the supply rate of a molten material. The specific manufacturing conditions vary depending on the composition of the magnetic powder to be manufactured or the desired productivity.

In the powder magnetic core according to this embodiment, the binder layer includes a function of binding particles of the magnetic powder. The binder layer includes a low melting glass and a resin material. In this embodiment, the total amount of the low melting glass and the resin material is less than 10 volume % with respect to the amount of the magnetic powder of the powder magnetic core. The low melting glass may be a phosphate-based glass, a tin phosphate-based glass, a borate-based glass, a silicate-based glass, a boro-silicate-based glass, a bariumsilicate-based glass, a bismuth oxide-based glass, a germanate-based glass, a vanadate-based glass, an aluminophosphate-based glass, an arsenate-based glass, a telluride-based glass or the like. In particular, in the present disclosure, a phosphate-based or a tin phosphate-based low melting glass can be used. Further, the volume percentage of the low melting glass with respect to the volume of the magnetic powder is equal to or larger than 0.5 volume % but equal to or smaller than 6 volume %, or for instance, equal to or larger than 1.25 volume % but equal to or smaller than 3 volume %.

Further, the resin material included in the binder layer may be at least one type of resin material selected from the group consisting of a phenol resin, a polyimide resin, an epoxy resin, and an acrylic resin. Further, the volume percentage of the resin material with respect to the volume of magnetic powder is equal to or larger than 0.5 volume % but equal to or smaller than 9 volume %, or for instance, equal to or larger than 1 volume % but equal to or smaller than 5 volume %.

The powder magnetic core according to this embodiment having the aforementioned configuration contains 88 volume % or more of magnetic powder, and the percentage of parts of the binder layer having thicknesses of 20 nm or smaller in the binder layer that is present between particles of the magnetic powder is equal to or smaller than 6% (not including 0%). Therefore, it becomes possible to maintain a sufficiently high insulation between particles of the magnetic powder while decreasing the thickness of the binder layer and thus increasing the filling percentage of the magnetic powder. Accordingly, with the powder magnetic core according to this embodiment, it is possible to reduce loss in the inductor in a high frequency range while reducing the size thereof.

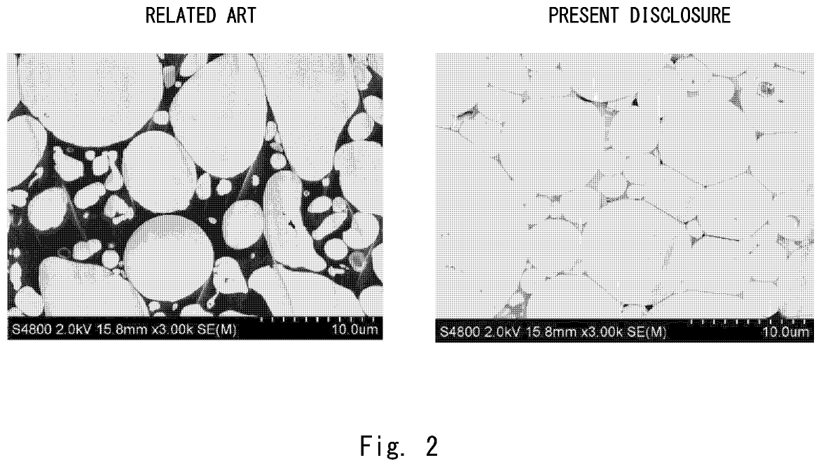

FIG. 2 shows electron micrographs of a powder magnetic core according to related art and the powder magnetic core according to the present disclosure. In the related art shown in FIG. 2, the filling percentage of the magnetic powder is low. On the other hand, the filling percentage of the magnetic powder of the powder magnetic core according to the present disclosure is higher than the filling percentage of the magnetic powder of the powder magnetic core according to related art. Therefore, even when a large current is made to flow through the inductor, the inductor exhibits high inductance characteristics.

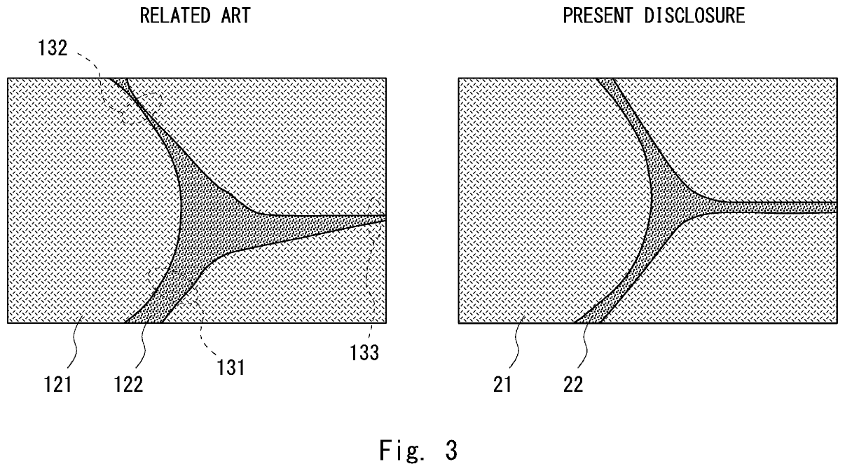

FIG. 3 is a schematic view for describing the microstructure of the powder magnetic core according to related art and the microstructure of the powder magnetic core according to the present disclosure. In the related art shown in FIG. 3, the thickness of a binder layer 122 that is present between particles of the magnetic powder 121 is uneven. For example, while the thickness of the binder layer 122 is large in a region 131, the thickness of the binder layer 122 is small in regions 132 and 133. That is, in this case, the percentage of parts of the binder layer having thicknesses of 20 nm or smaller (i.e., the percentage of the parts such as the regions 132 and 133 where the binder layer is thin) in the binder layer 122 that is present between particles of the magnetic powder 121 is high. Therefore, the percentage of parts where the thickness of the binder layer 122 is large becomes high.

On the other hand, in the powder magnetic core according to the present disclosure, the thickness of the binder layer 22 that is present between particles of the magnetic powder 21 is even. That is, the percentage of parts of the binder layer having thicknesses of 20 nm or smaller (i.e., the percentage of the parts where the binder layer is thin) in the binder layer 22 that is present between particles of the magnetic powder 21 is small. Therefore, as a result, the percentage of the parts where the binder layer 22 is thick becomes small, and the thickness of the binder layer 22 becomes even as a whole. As one example, the median thickness of the binder layer 22 of the powder magnetic core according to the present disclosure is 31-68 nm.

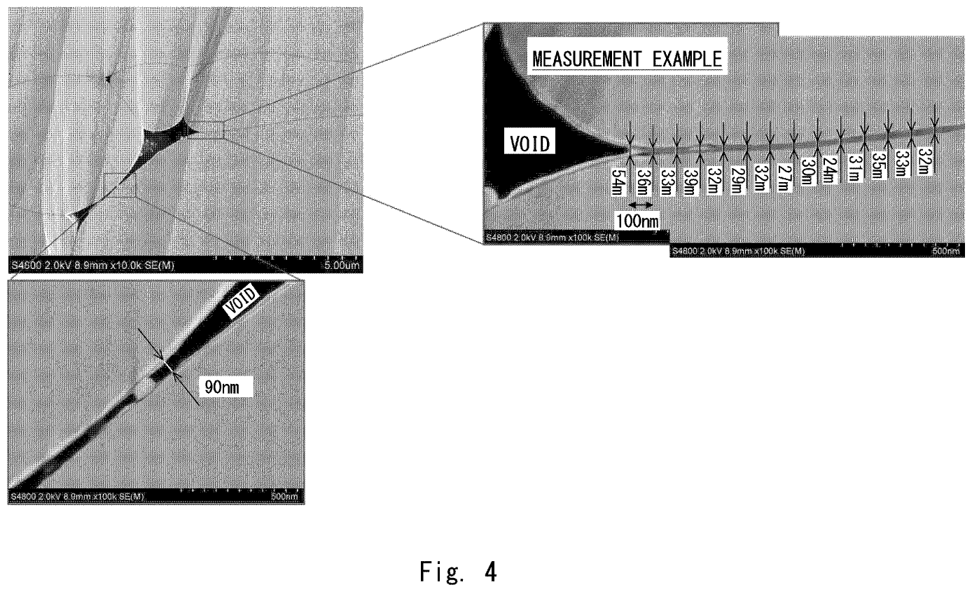

FIG. 4, which shows electron micrographs of the microstructure of the powder magnetic core according to this embodiment, is a diagram for describing a method of obtaining “the percentage of parts of a binder layer having thicknesses of 20 nm or smaller in the binder layer that is present between particles of the magnetic powder”. When the thicknesses of the binder layer are measured, a region in which a space between particles of the magnetic powder is filled with the binder and the gap between particles of the magnetic powder is 200 nm or smaller for a length of 100 nm or more is specified using electron micrographs (SEM images) of the powder magnetic core. Then, in the specified region, the thickness of the binder layer is measured for every 100 nm. FIG. 4 shows, in the right diagram, a measurement example. Whether or not the binder is present between particles of the magnetic powder can be determined using the contrast of an SEM image or results of analyzing elements in an Energy dispersive X-ray spectroscopy (EDX). For example, the number of measurement points of the thickness of the binder layer may be 400 or larger. Note that the gap between particles of the magnetic powder may be measured by assuming a normal line at a point on the surface of one magnetic powder and measuring the distance between two magnetic powder particles in the direction of the normal line.

When, for example, the number of measurement points is 400 and the number of measurement points where the thickness of the binder layer is equal to or smaller than 20 nm is 20, “the percentage of parts of the binder layer having thicknesses of 20 nm or smaller in the binder layer that is present between particles of the magnetic powder”=(20/400)×100=5[%].

Note that, as shown in the lower left diagram of FIG. 4, a powder magnetic core in which the gap between particles of the magnetic powder is not filled with a binder even when this gap is 200 nm or smaller (the part shown in the drawing is 90 nm) is excluded from the target of measurement.

### Method for Manufacturing Powder Magnetic Core

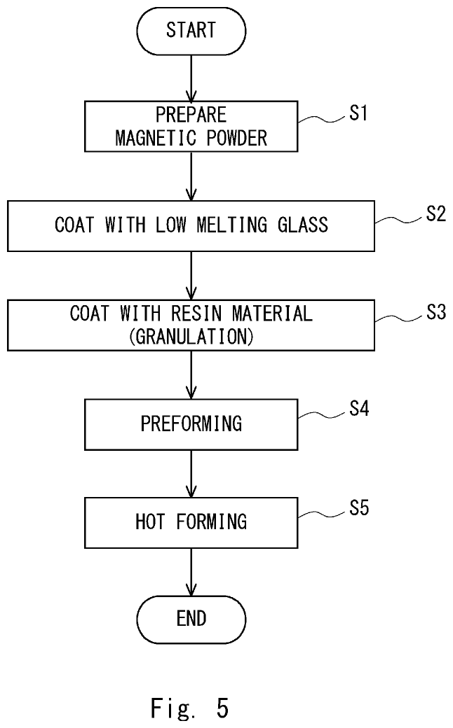

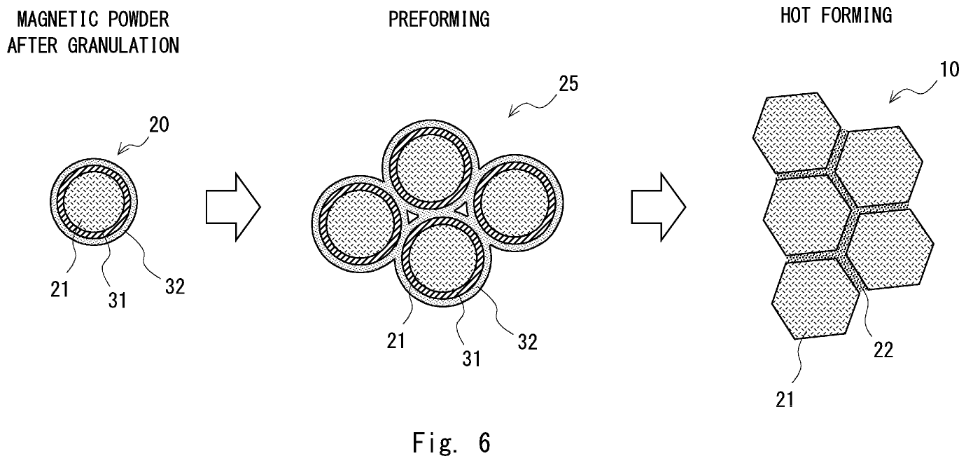

Next, a method for manufacturing the powder magnetic core according to this embodiment will be described. FIG. 5 is a flowchart for describing the method for manufacturing the powder magnetic core according to this embodiment. FIG. 6 is a schematic view for describing the method for manufacturing the powder magnetic core according to this embodiment.

As shown in FIG. 5, when the powder magnetic core is prepared, the magnetic powder is prepared first (Step S1). The magnetic powder may be the aforementioned magnetic powder. The magnetic powder can be made of a magnetic material that is softened at 400 °C or higher (a material that is easily deformed during hot forming). For example, by vacuum melting raw materials of the magnetic powder and then performing powderization and quenching concurrently using a water atomizing method, an amorphous magnetic powder can be obtained. The magnetic powder thus obtained may be classified as needed to remove abnormally coarsened powder.

Next, the magnetic powder is coated with a low melting glass (Step S2). The low melting glass may be made of a material that is softened at 400 °C or higher, that is, a material that is softened during hot forming and serves as an insulation material or a bonding material after hot forming. The low melting glass may be, for example, a phosphate-based glass. When the magnetic powder is coated with the low melting glass, a wet thin-film formation method such as a mechanofusion method or a sol-gel method, or a dry thin-film formation method such as sputtering may be used. For example, according to the mechanofusion method, a layer of the low melting glass can be formed on the surface of the magnetic powder by mixing the magnetic powder with the low melting glass powder while applying a strong mechanical energy.

As one example, 1000 g of magnetic powder is mixed with 10 g of low melting glass powder, and the magnetic powder is coated with the low melting glass using a mechanofusion method. Accordingly, the volume percentage of the low melting glass that coats the magnetic powder with respect to the volume of the magnetic powder may be made equal to or larger than 0.5 volume % but equal to or smaller than 6 volume %.

Next, the magnetic powder coated with the low melting glass is coated with the resin material for granulation (Step S3). This resin material may be the aforementioned resin material. The resin material can be made of a material that is softened at about 100 °C and serves as an insulation material or a bonding material after hot forming. Further, the resin material can be a material that is not likely to be decomposed during hot forming (at a high temperature). When the magnetic powder is coated with the resin material (granulated), a rolling granulation method, a spray-dry method or the like may be used. Specifically, by mixing the resin material dissolved in an organic solvent with the magnetic powder coated with the low melting glass and drying the resulting object, a resin layer can be formed on the low melting glass of the magnetic powder.

FIG. 6 shows, in the left diagram, a magnetic powder 20 after granulation. As shown in FIG. 6, in the magnetic powder 20 after granulation, a magnetic powder 21 is coated with a low melting glass 31, and further the low melting glass 31 is coated with a resin material 32. As one example, the diameter of the magnetic powder 21 is 9 μm, the thickness of the low melting glass 31 is 20 nm, and the thickness of the resin material is 20 nm.

Next, the magnetic powder after granulation is preformed (Step S4). For example, preforming can be conducted by putting the magnetic powder after granulation into a die for pressurization (e.g., 500 kgf/cm² at room temperature), and heating the pressed powder body (i.e., green compact) to a predetermined temperature (e.g., 100 °C-150 °C) and curing the pressed powder body without pressurization. When the resin material that is used is a thermosetting resin, the intermediate formed body is formed using curing of resin during heating. When the resin material that is used is a thermoplastic resin, the intermediate formed body is formed by softening of the resin during heating and solidification during cooling.

That is, as shown in the central diagram of FIG. 6, when the magnetic powder after granulation is preformed, the particles of the magnetic powder 21 (coated with the low melting glass 31) are bonded to one another via the outermost resin material 32 and an intermediate formed body 25 is formed. Since the low melting glass is not softened at the preforming temperature (e.g., 150 °C), it does not exhibit bonding and flow properties. Note that the preforming process (Step S4) may be omitted.

Next, the intermediate formed body after preforming (when Step S4 is omitted, magnetic powder after granulation) is subject to hot forming (Step S5). The hot forming is conducted by heating the intermediate formed body that has been preformed (or the magnetic powder after granulation) under pressure in a state in which it is put into the die. For example, the heating temperature is set as follows.

When the magnetic powder that has been used is a metallic glass, the temperature when the magnetic powder is subject to hot forming is set to a temperature equal to or higher than one of a softening temperature of the low melting glass and a glass transition temperature of the magnetic powder which is higher than the other one, but is equal to or lower than a crystallization temperature of the magnetic powder. By setting the hot forming temperature to a temperature equal to or higher than the glass transition temperature of the magnetic powder, plastic deformation of the magnetic powder is more likely to occur, whereby a high filling percentage of the magnetic powder can be obtained. As one example, the hot forming temperature is equal to or higher than 450 °C but equal to or lower than 500 °C.

When the magnetic powder that has been used is a nanocrystallized powder, the temperature when the magnetic powder is subject to hot forming is set to a temperature equal to or higher than one of a softening temperature of the low melting glass and a first crystallization temperature of the magnetic powder which is higher than the other one but is equal to or lower than a second crystallization temperature of the magnetic powder. By setting the hot forming temperature to a temperature around the first crystallization temperature, an a-Fe phase is crystallized, and at the same time plastic deformation of the magnetic powder becomes more likely to occur, whereby a high filling percentage of the magnetic powder can be obtained. As one example, the hot forming temperature is set to be a temperature equal to or higher than 400 °C but equal to or lower than 500 °C Further, in the present disclosure, the hot forming temperature may be equal to or higher than one of the softening temperature of the low melting glass and the first crystallization temperature of the magnetic powder+40 °C which is higher than the other one. The first crystallization temperature and the second crystallization temperature are defined as follows. That is, heat treatment of the magnetic material having an amorphous structure causes crystallization to occur more than once. The temperature at which crystallization starts first is the first crystallization temperature and the temperature at which crystallization then starts is the second crystallization temperature. More specifically, the magnetic powder includes at least two exothermic peaks that exhibit crystallization in the heating process of a DSC curve obtained by differential scanning calorimetry (DSC). Of the exothermic peaks, the exothermic peak on the lowest temperature side indicates the first crystallization temperature at which an a-Fe phase is crystallized, and the next exothermic peak indicates the second crystallization temperature at which a boride or the like is crystallized.

In this embodiment, the heating temperature can be set to a temperature in the aforementioned temperature range and temperature conditions may be such that the value of the iron loss of the powder magnetic core becomes small.

Further, the pressure when hot forming is performed is, for example, 5-10 ton·f/cm². If the pressure is too low, the filling percentage of the formed body (powder magnetic core) becomes low and the iron loss of the powder magnetic core becomes large. On the other hand, if the pressure is too high, the die is severely worn, which is not desirable in terms of cost. Therefore, the pressure can be set to a pressure in the aforementioned range.

Further, the hot forming may be performed within a range of 5-60 seconds, or equal to or shorter than 30 seconds. If the forming time is too short, heat does not sufficiently reach the inside of the formed body and a sufficient amount of deformation due to softening of the magnetic powder cannot be obtained, whereby the filling percentage of the formed body becomes low and the iron loss of the powder magnetic core becomes large. On the other hand, if the forming time is too long, thermal decomposition of the resin material used for the binder layer advances, whereby the effect of suppressing the flow properties of the low melting glass is reduced and the iron loss of the powder magnetic core becomes large. Therefore, the hot forming time may be set within a range in which heat is sufficiently transferred to the interior of the formed body, deformation due to softening of the magnetic core is completed, thermal decomposition of the resin material used for the binder layer does not advance, and the cost is not high. The forming time may be set to a time within the aforementioned range.

As one example, hot forming may be performed at a hot forming temperature: 480 °C, at a hot forming pressure: 8 ton·f/cm², and for a hot forming time: 10 seconds.

As shown in the right view of FIG. 6, in the formed body (powder magnetic core) 10 after the hot forming, the particles of the magnetic powder 21 are bonded to one another via the binder layer 22 including a low melting glass and a resin material. In this embodiment, the volume percentage of the particles of the magnetic powder contained in the powder magnetic core 10 is set to be 88 volume % or higher. Further, the percentage of parts of the binder layer having thicknesses of 20 nm or smaller in the binder layer that is present between particles of the magnetic powder is set to be equal to or smaller than 6%. Accordingly, it becomes possible to enhance the filling percentage of the magnetic powder and to maintain a sufficiently high insulation between particles of the magnetic powder. Accordingly, with the method for manufacturing the powder magnetic core according to this embodiment, it is possible to prepare a powder magnetic core capable of achieving a low loss in a high frequency range while reducing the size thereof.

As described in Background, it is required for inductors to have small sizes and exhibit high inductance characteristics even when a large current is made to flow therethrough. Further, inductors having a low loss in a high frequency range have been required. In order to provide the inductors that satisfy the above conditions, it is required for a powder magnetic core used for an inductor to have a high filling percentage of the magnetic powder and to maintain a sufficiently high insulation between particles of the magnetic powder. However, according to related art, it is difficult to increase the filling percentage of the magnetic powder while maintaining a sufficiently high insulation between particles of the magnetic powder.

On the other hand, in the method for manufacturing the powder magnetic core according to this embodiment, the binder layer is formed using a low melting glass and a resin material. In this manner, by using the low melting glass and the resin material as the binder, even when the amount of binder that is added is small, a thin binder layer (insulating layer) having a uniform thickness can be formed. That is, by using a binder component that is likely to flow easily (low melting glass) and a binder component that is not likely to flow easily (resin material) in a mixed manner at a hot forming temperature, a sufficiently high insulation between particles of the magnetic powder can be maintained even when the amount of binder that is added is made small. That is, according to this embodiment, by intentionally leaving the resin during hot forming, the flow of the low melting glass that is relatively softer than a magnetic powder is can be suppressed to some extent, which prevents particles of the magnetic powder from contacting each other without using a binder layer (insulating layer).

Further, in the method for manufacturing the powder magnetic core according to this embodiment, the amount of resin material, which is used as a binder, is made small, whereby it is possible to reduce the amount of gas generated in accordance with decomposition of the resin material during hot forming. It is therefore possible to prevent cracks from occurring in a formed body (the powder magnetic core) due to the generated gas.

In this embodiment, the iron loss of the powder magnetic core can be 2500 kW/m³ or smaller, or for instance, 1500 kW/m³ or smaller.

### Dimension of Powder Magnetic Core

Next, the dimension of the powder magnetic core according to this embodiment will be described.

In this embodiment, when the length of the powder magnetic core in the vertical direction (in the example shown in FIG. 1, a distance h) is larger than 3.5 mm, of the distances between the molding dies when the powder magnetic core is held by the molding dies in the horizontal cross-section of the powder magnetic core, the distance between the molding dies in a direction substantially vertical to the direction in which the part inside the powder magnetic core where it takes the longest time for heat to be transferred during the hot forming of the powder magnetic core is extended is set to be equal to or smaller than 3.5 mm. Hereinafter, the dimension of the powder magnetic core will be described with specific examples.

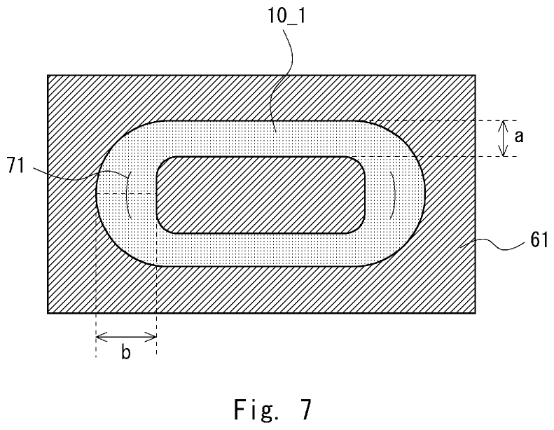

When, for example, the shape of the horizontal cross-section of the powder magnetic core is the one as shown in a powder magnetic core 10_1 in FIG. 7 (the powder magnetic core 10_1 shown in FIG. 7 corresponds to the powder magnetic core 10_1 shown in FIG. 1), the powder magnetic core 10_1 is formed in a state in which it is held by a molding die 61 during hot forming. At this time, heat is transferred from the molding die 61 to the powder magnetic core 10_1, and the part inside the power magnetic core 10_1 where heat is least likely to be transferred is the part indicated by the reference numeral 71. In this embodiment, a distance b between molding dies in a direction substantially vertical to the direction in which the part 71 inside the powder magnetic core 10_1 where it takes the longest time for heat to be transferred is extended is set to be equal to or smaller than 3.5 mm. By making the powder magnetic core have the aforementioned dimension, heat can be quickly transferred to the whole powder magnetic core 10_1 during hot forming.

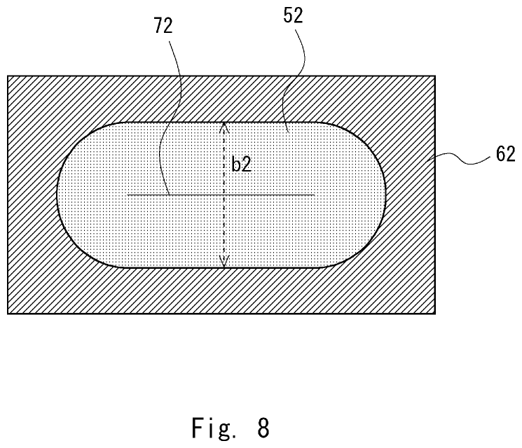

Further, when, for example, the shape of the horizontal cross-section of the powder magnetic core is the one as shown in a powder magnetic core 52 shown in FIG. 8 (i.e., shape with no cavity in the center), the powder magnetic core 52 is formed in a state in which it is held by a molding die 62 during hot forming. At this time, heat is transferred from the molding die 62 to the powder magnetic core 52, and the part inside the power magnetic core 52 where heat is least likely to be transferred is the part indicated by the reference numeral 72. In this embodiment, a distance b2 between the molding dies in a direction substantially vertical to the direction in which the part 72 inside the powder magnetic core 52 where it takes the longest time for heat to be transferred is extended is set to be equal to or smaller than 3.5 mm. By making the powder magnetic core have the aforementioned dimension, heat can be quickly transferred to the whole powder magnetic core 52 during hot forming.

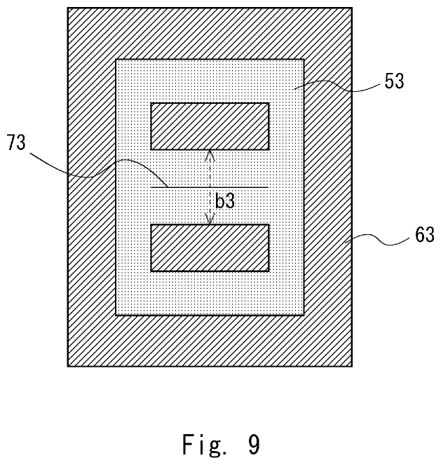

Further, when, for example, the shape of the horizontal cross-section of the powder magnetic core is the one as shown in a powder magnetic core 53 shown in FIG. 9 (i.e., shape with two cavities in the center), the powder magnetic core 53 is formed in a state in which it is held by a molding die 63 during hot forming. At this time, heat is transferred from the molding die 63 to the powder magnetic core 53, and the part inside the power magnetic core 53 where heat is least likely to be transferred is the part indicated by the reference numeral 73. In this embodiment, a distance b3 between the molding dies in a direction substantially vertical to the direction in which the part 73 inside the powder magnetic core 53 where it takes the longest time for heat to be transferred is extended is set to be equal to or smaller than 3.5 mm. By making the powder magnetic core have the aforementioned dimension, heat can be quickly transferred to the whole powder magnetic core 53 during hot forming.

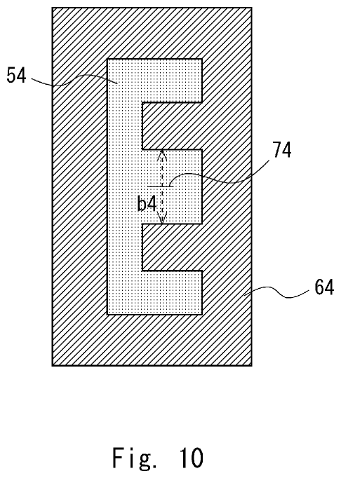

Further, when, for example, the shape of the horizontal cross-section of the powder magnetic core is the one as shown in a powder magnetic core 54 shown in FIG. 10 (i.e., E-type core), the powder magnetic core 54 is formed in a state in which it is held by a molding die 64 during hot forming. At this time, heat is transferred from the molding die 64 to the powder magnetic core 54, and the part inside the power magnetic core 54 where heat is least likely to be transferred is the part indicated by the reference numeral 74. In this embodiment, a distance b4 between molding dies in a direction substantially vertical to the direction in which the part 74 inside the powder magnetic core 54 where it takes the longest time for heat to be transferred is extended is set to be equal to or smaller than 3.5 mm. By making the powder magnetic core have the aforementioned dimension, heat can be quickly transferred to the whole powder magnetic core 54 during hot forming.

Note that the configuration examples shown in FIGS. 7-10 are merely examples, and the dimension of the powder magnetic core according to this embodiment can also be applied to powder magnetic cores having other structures. Further, when, for example, the shape of the horizontal cross-section of the powder magnetic core is a circular shape, the part inside the powder magnetic core 54 where it takes the longest time for heat to be transferred is a point. In this case, the diameter of the circle that passes this point is set to be 3.5 mm or smaller. Further, in this embodiment, the length of the powder magnetic core in the vertical direction may be equal to or smaller than 3.5 mm. In this manner, when the length of the powder magnetic core in the vertical direction is set to be equal to or smaller than 3.5 mm, the distance between the molding dies in the horizontal cross-section of the powder magnetic core may be set to a desired value.

As described above, by making the powder magnetic core according to this embodiment have the aforementioned dimension, heat can be easily transferred to the powder magnetic core during hot forming. It is therefore possible to reduce the hot forming time and to prevent thermal decomposition of the resin material. Accordingly, the effect of suppressing the flow properties of the low melting glass is enhanced and the iron loss of the powder magnetic core can be reduced.

### Examples

Next, Examples according to the present disclosure will be described.

### Experiment 1

Samples according to Experiment 1 were prepared using the aforementioned method for manufacturing the powder magnetic core (see FIG. 5). The powder magnetic core according to Experiment 1 was formed in a toroidal shape having an outer diameter of 13 mm, an inner diameter of 8 mm, and a length of 5 mm. Specifically, first, a magnetic powder was prepared. An Fe—B—P—Nb—Cr-based powder, which is a metallic glass powder having a particle size of 9 μm (median diameter D50), was used as the magnetic powder. Next, the magnetic powder and a low melting glass powder were mixed, and the magnetic powder was coated with a low melting glass using a mechanofusion method. A phosphate-based glass was used as the low melting glass. At this time, 2.5 volume % of low melting glass was mixed with the magnetic powder.

After that, the magnetic powder coated with the low melting glass was coated with a resin material and was granulated. Each of the resins as shown in Table 1 was used as the resin material. At this time, 2.5 volume % of each resin material was mixed with the magnetic powder. The “loss on heating of the resin at 500 °C” in Table 1 indicates results of a thermogravimetric analysis of the resin (measurement conditions: air atmosphere, heating rate 100 °C/min), which shows that the smaller the loss on heating is, the higher the heat resistance of the resin is.

Next, the magnetic powder after granulation was put into a die and pressurized at 500 kgf/cm², and then the pressed powder body was heated and cured at 150 °C without pressurization, thereby preforming the intermediate formed body. After that, the intermediate formed body after being preformed was subject to hot forming in a state in which it is put into a die. The hot forming was performed under a forming temperature of 490 °C, a pressing pressure of 8 tonf/cm², and for a pressing time of 30 seconds.

Regarding each of the samples prepared as described above, the powder filling percentage of the magnetic core, the magnetic permeability, the iron loss, the percentage of parts of the binder layer having thicknesses of 20 nm or smaller in the binder layer that is present between particles of the magnetic powder, and the median thickness of the binder layer were measured. The number of measurement points of the thickness of the binder layer was 1000.

The powder filling percentage of the magnetic core was obtained by comparing the volume of the magnetic powder included in the magnetic core with the volume of the whole magnetic core measured by an Archimedes method. The volume of the magnetic powder included in the magnetic core is obtained by first obtaining the weight of the magnetic powder included in the magnetic core by subtracting the weight of the low melting glass added as a binder and the remaining resin material from the weight of the entire magnetic core and then dividing the weight of the magnetic powder by the true density of the magnetic powder.

The magnetic permeability was obtained using an impedance analyzer at a frequency of 1 MHz, and the iron loss was obtained by preparing a powder magnetic core having a toroidal shape and measuring the prepared powder magnetic core using a B—H analyzer (manufactured by IWATSU ELECTRIC CO., LTD.) by a two-coil method. The measurement was performed under sinusoidal excitation with 1 MHz and 50 mT.

The percentage of parts of the binder layer having thicknesses of 20 nm or smaller in the binder layer that is present between particles of the magnetic powder (hereinafter this percentage will be referred to as a “percentage of parts of the binder layer of 20 nm or smaller”) was measured by using the aforementioned method using an electron micrograph. Further, the median thickness of the binder layer was also measured using an electron micrograph.

Table 1 shows the types of resins used in the respective samples and the results of measurement of each sample. As shown in Table 1, in Example 1-1 in which a phenol resin was used as a binder resin, Example 1-2 in which a polyimide resin was used as a binder resin, Example 1-3 in which an epoxy resin was used as a binder resin, and Example 1-4 in which an acrylic resin was used as a binder resin, the values of the iron loss became equal to or smaller than 1100, which were good. Further, in Examples 1-1 to 1-4, the percentage of parts of the binder layer of 20 nm or smaller was equal to or smaller than 2.2%, which was good. In particular, in Examples 1-1 to 1-3, the percentages of parts of the binder layer of 20 nm or smaller were smaller than 1% and the values of the iron loss were smaller than 1000.

On the other hand, in Comparative Example 1-1 in which a silicone resin was used as a binder resin, Comparative Example 1-2 in which a polyvinyl butyral (PVB) resin was used as a binder resin, and Comparative Example 1-3 in which no resin was used, the values of the iron loss were equal to or larger than 5500, which were large.

From the above results, it can be said that a phenol resin, a polyimide resin, an epoxy resin, and an acrylic resin may be used as the resin to be used for the binder layer.

TABLE 1
Experiment 1

| | | | Powder | | | | |
|---|---|---|---|---|---|---|---|
| | | Loss on | filling | | | Percentage of | Median |
| | | heating | percentage of | Permea- | Iron loss | parts of binder | thickness |
| | | of resin | magnetic core | bility | @1 MHz, 50 mT | layer of 20 nm | of binder |
| | Type of resin | at 500° C. | (vol. %) | @1 MHz | (kW/m³) | or smaller | layer (nm) |
| Example 1-1 | Phenol | 14% | 93.7% | 121 | 900 | 0.92% | 40 |
| Example 1-2 | Polyimide | 3% | 91.9% | 118 | 780 | 0.83% | 37 |
| Example 1-3 | Epoxy | 65% | 92.3% | 157 | 970 | 0.95% | 42 |
| Example 1-4 | Acryl | 73% | 92.8% | 182 | 1,100 | 2.2% | 34 |
| Comparative | Silicone | 19% | 91.4% | 108 | 10,000 | 10.2% | 33 |
| Example 1-1 | | | | | | | |
| Comparative | PVB | 83% | 93.1% | 188 | 5,500 | 8.3% | 31 |
| Example 1-2 | | | | | | | |
| Comparative | No resin | — | 95.9% | 192 | 17,000 | 13.3% | 27 |
| Example 1-3 | | | | | | | |

### Experiment 2

In Experiment 2, a powder magnetic core whose particle size of a metallic glass powder (median diameter D50), which is a magnetic powder, is changed has been prepared. In Experiment 2, a phosphate-based glass and a phenol resin were used as the material for the binder. A method similar to that in Experiment 1 was used to prepare the powder magnetic core and measure the samples. In Comparative Example 2-1 and Example 2-1, the volume percentage of the phosphate-based glass with respect to the volume of the magnetic powder was set to 5 volume % and the volume percentage of the phenol resin with respect to the volume of the magnetic powder was set to 2.5 volume %. In Example 2-2, the volume percentage of the phosphate-based glass with respect to the volume of the magnetic powder was set to 2.5 volume % and the volume percentage of the phenol resin with respect to the volume of the magnetic powder was set to 2.5 volume %. Further, as shown in Table 2, since the softening temperature of the phosphate-based glass was 400 °C, the glass transition temperature of the magnetic powder was 480 °C, and the crystallization temperature of the magnetic powder was 510 °C, the forming temperature was set to 490 °C.

As shown in Table 2, in Comparative Example 2-1 in which the particle size of the metallic glass powder was 4 μm, the value of the iron loss was 12000 and the percentage of parts of the binder layer of 20 nm or smaller was 13.5%, which were both large. On the other hand, in Example 2-1 in which the particle size of the metallic glass powder was 7 μm and Example 2-2 in which the particle size of the metallic glass powder was 9 μm, the values of the iron loss were respectively 1100 and 900, which were good. Further, the percentage of parts of the binder layer of 20 nm or smaller in Example 2-1 and that in Example 2-2 were respectively 1.7% and 0.92%, which were good. Therefore, in Experiment 2, when the particle size of the metallic glass powder was 7 μm or larger, the iron loss and the percentage of parts of the binder layer of 20 nm or smaller were good.

While the phosphate-based glass and the phenol resin were used as the material for the binder in Experiment 2, the present inventors also conducted an experiment in which 5 volume % of phosphate-based glass and 2.5 volume % of polyimide resin with respect to the volume of the magnetic powder are used as a binder. It has been confirmed, in this case, that, even when the particle size of the metallic glass (magnetic powder) was 2 μm, the filling percentage of the powder magnetic core became equal to or higher than 88 volume %, the percentage of parts of the binder layer of 20 nm or smaller was equal to or smaller than 6%, and the iron loss was equal to or smaller than 2500.

TABLE 2
Experiment 2

| | | Particle | | | | Powder |
|---|---|---|---|---|---|---|
| | | diameter | Glass | Crystalli- | | filling |
| | Type of | D50 of | transition | zation | Molding | percentage of |
| | magnetic | magnetic | temperature | temperature | temperature | magnetic core |
| | powder | powder | (° C.) | (° C.) | (° C.) | (vol. %) |
| Comparative | Metallic | 4 | 480 | 510 | 490 | 89.3 |
| Example 2-1 | glass | | | | | |
| Example 2-1 | Metallic | 7 | 480 | 510 | 490 | 90.6 |
| | glass | | | | | |
| Example 2-2 | Metallic | 9 | 480 | 510 | 490 | 93.7 |
| | glass | | | | | |

| | | | Percentage of | Median |
|---|---|---|---|---|
| | Permea- | Iron loss | parts of binder | thickness |
| | bility | @1 MHz, 50 mT | layer of 20 nm | of binder |
| | @1 MHz | (kW/m³) | or smaller | layer (nm) |
| Comparative | 75 | 12000 | 13.5% | 27 |
| Example 2-1 | | | | |
| Example 2-1 | 103 | 1100 | 1.7% | 43 |
| Example 2-2 | 120 | 900 | 0.92% | 40 |

### Experiment 3

In Experiment 3, a powder magnetic core whose particle size of a nanocrystallized powder (median diameter D50), which is an Fe—Si—B—P—Cu—Cr-based magnetic powder, is changed was prepared. In Experiment 3, a phosphate-based glass and a phenol resin were used as the material for the binder. A method similar to that in Experiment 1 was used to prepare the powder magnetic core and measure the samples. In Experiment 3, the volume percentage of the phosphate-based glass with respect to the volume of the magnetic powder was set to 2.5 volume % and the volume percentage of the phenol resin with respect to the volume of the magnetic powder was set to 2.5 volume %. Further, as shown in Table 3, the forming temperature was set to a temperature between one of the softening temperature of the low melting glass (400 °C) and the first crystallization temperature of the magnetic powder which is higher than the other one and the second crystallization temperature of the magnetic powder.

As shown in Table 3, in Example 3-1 in which the particle size of the nanocrystallized powder was 11 μm, Example 3-2 in which the particle size of the nanocrystallized powder was 14 μm, and Example 3-3 in which the particle size of the nanocrystallized powder was 23 μm, the values of the iron loss were equal to or smaller than 2500 and the percentages of parts of the binder layer of 20 nm or smaller were 1% or smaller, which were good. In particular, in Example 3-1 in which the particle size of the nanocrystallized powder was 11 μm, the value of the iron loss was 860, which was very good. On the other hand, in Comparative Example 3-1 in which the particle size of the nanocrystallized powder was 41 μm, the value of the iron loss was 5300, which was large, and the percentage of parts of the binder layer of 20 nm or smaller became 0%.

It has been seen from the results of Experiments 2 and 3 that, if the particle size is too small, the median thickness of the binder layer becomes too thin, whereby a sufficiently high insulation between particles of the magnetic powder cannot be ensured, and the iron loss of the powder magnetic core becomes large due to eddy current loss between particles of the magnetic powder. On the other hand, if the particle size is too large, the median thickness of the binder layer becomes large, whereby a sufficiently high insulation between particles of the magnetic powder can be ensured, but at the same time, the iron loss of the powder magnetic core becomes large due to eddy current loss within the particles of magnetic powder. From the above experiments, the particle size of the magnetic powder may be equal to or larger than 2 μm but equal to or smaller than 25 μm, or for instance, equal to or larger than m but equal to or smaller than 15 μm.

TABLE 3
Experiment 3

| | | Particle | First | Second | | Powder |
|---|---|---|---|---|---|---|
| | | diameter | crystalli- | crystalli- | | filling |
| | Type of | D50 of | zation | zation | Molding | percentage of |
| | magnetic | magnetic | temperature | temperature | temperature | magnetic core |
| | powder | powder | (° C.) | (° C.) | (° C.) | (vol. %) |
| Example 3-1 | Nanocrystal | 11 | 420 | 510 | 470 | 92.9 |
| Example 3-2 | Nanocrystal | 14 | 400 | 490 | 460 | 92.0 |
| Example 3-3 | Nanocrystal | 23 | 350 | 470 | 440 | 94.3 |
| Comparative | Nanocrystal | 41 | 400 | 510 | 480 | 93.6 |
| Example 3-1 | | | | | | |

| | | | Percentage of | Median |
|---|---|---|---|---|
| | Permea- | Iron loss | parts of binder | thickness |
| | bility | @1 MHz, 50 mT | layer of 20 nm | of binder |
| | @1 MHz | (kW/m³) | or smaller | layer (nm) |
| Example 3-1 | 115 | 860 | 0.62% | 46 |
| Example 3-2 | 118 | 1300 | 0.27% | 58 |
| Example 3-3 | 114 | 2500 | 0.15% | 85 |
| Comparative | 100 | 5300 | 0% | (220) |
| Example 3-1 | | | | |

### Experiment 4

In Experiment 4, a powder magnetic core whose blending ratio of a phosphate-based glass, which is a material for the binder, to a phenol resin is changed was prepared. In Experiment 4, a metallic glass powder having a particle size of 9 m (median diameter D50) was used as the magnetic powder. A method similar to that in Experiment 1 was used to prepare the powder magnetic core and measure the samples. Table 4 shows the blending ratio of the phosphate-based glass and the phenol resin in each of the samples.

As shown in Table 4, in Comparative Example 4-1 in which the blending ratio (volume %) of the phosphate-based glass to the phenol resin was 2.5:0 (i.e., no phenol resin is added), the value of the iron loss was 17000 and the percentage of parts of the binder layer of 20 nm or smaller was 13.3%, which were both large. Further, in Example 4-1 in which the blending ratio (volume %) of the phosphate-based glass to the phenol resin was 2.5:2.5, the value of the iron loss was 900 and the percentage of parts of the binder layer of 20 nm or smaller was 0.92%, which were good. In Example 4-2 in which the blending ratio (volume %) of the phosphate-based glass to the phenol resin was 2.5:5, the value of the iron loss was 1100 and the percentage of parts of the binder layer of 20 nm or smaller was 0.57%, which were good. On the other hand, in Comparative Example 4-2 in which the blending ratio (volume %) of the phosphate-based glass to the phenol resin was 2.5:10, the value of the iron loss was 2100, but at the same time the percentage of parts of the binder layer of 20 nm or smaller was 0% and the powder filling percentage was 84.2%, which were small.

TABLE 4
Experiment 4

| | | | | Powder | | | | |
|---|---|---|---|---|---|---|---|---|
| | | | | filling | | | Percentage of | Median |
| | Type of | Ratio of glass | Ratio of resin | percentage of | Permea- | Iron loss | parts of binder | thickness |
| | magnetic | to magnetic | to magnetic | magnetic core | bility | @1 MHz, 50 mT | layer of 20 nm | of binder |
| | powder | powder 100 | powder 100 | (vol. %) | @1 MHz | (kW/m³) | or smaller | layer (nm) |
| Comparative | Metallic | 2.5 | 0 | 95.9 | 180 | 17000 | 13.3% | 27 |
| Example 4-1 | glass | | | | | | | |
| Example 4-1 | Metallic | 2.5 | 2.5 | 93.3 | 122 | 900 | 0.92% | 40 |
| | glass | | | | | | | |
| Example 4-2 | Metallic | 2.5 | 5 | 89.0 | 84 | 1100 | 0.57% | 68 |
| | glass | | | | | | | |
| Comparative | Metallic | 2.5 | 10 | 84.2 | 52 | 2100 | 0% | 131 |
| Example 4-2 | glass | | | | | | | |

### Experiment 5

In Experiment 5, a powder magnetic core in which the blending ratio of a phosphate-based glass, which is a material for the binder, to a phenol resin is changed was prepared. In Experiment 5, a nanocrystallized powder having a particle size of 11 μm (median diameter D50) was used as a magnetic powder. A method similar to that in Experiment 1 was used to prepare the powder magnetic core and measure the samples. Table 5 shows the blending ratio of the phosphate-based glass to the phenol resin of each of the samples.

As shown in Table 5, in Examples 5-1 to 5-5, the iron loss was equal to or smaller than 2500, the percentage of parts of the binder layer of 20 nm or smaller was equal to or smaller than 6% (not including 0%), which were good. In particular, in Example 5-3 in which the blending ratio (volume %) of the phosphate-based glass to the phenol resin was 2.5:2.5, the value of the iron loss was 860, which was very good. On the other hand, in Comparative Examples 5-1 to 5-3, the iron loss was equal to or smaller than 2500, but the filling percentage of the powder magnetic core was lower than 88 volume % and the magnetic permeability was also equal to or lower than 78, which were small.

From the results of Experiments 4 and 5, it can be said that the total amount of the low melting glass and the resin material with respect to the amount of the magnetic powder may be smaller than 10 volume %.

TABLE 5
Experiment 5

| | | | | Powder | | | | |
|---|---|---|---|---|---|---|---|---|
| | | | | filling | | | Percentage of | Median |
| | Type of | Ratio of glass | Ratio of resin | percentage of | Permea- | Iron loss | parts of binder | thickness |
| | magnetic | to magnetic | to magnetic | magnetic core | bility | @1 MHz, 50 mT | layer of 20 nm | of binder |
| | powder | powder 100 | powder 100 | (vol. %) | @1 MHz | (kW/m³) | or smaller | layer (nm) |
| Example 5-1 | Nanocrystal | 0.63 | 2.5 | 91.1 | 134 | 1600 | 4.1% | 32 |
| Example 5-2 | Nanocrystal | 1.25 | 2.5 | 92.2 | 128 | 900 | 1.1% | 35 |
| Example 5-3 | Nanocrystal | 2.5 | 2.5 | 92.9 | 115 | 860 | 0.62% | 46 |
| Example 5-4 | Nanocrystal | 5 | 2.5 | 88.9 | 95 | 1600 | 0.83% | 58 |
| Comparative | Nanocrystal | 7.5 | 2.5 | 86.9 | 78 | 2000 | 0.18% | 70 |
| Example 5-1 | | | | | | | | |
| Example 5-5 | Nanocrystal | 1.25 | 5 | 90.1 | 109 | 1400 | 0.78% | 63 |
| Comparative | Nanocrystal | 5 | 5 | 86.3 | 69 | 2200 | 0% | 88 |
| Example 5-2 | | | | | | | | |
| Comparative | Nanocrystal | 0.63 | 10 | 85.9 | 65 | 2500 | 0% | 105 |
| Example 5-3 | | | | | | | | |

### Experiment 6

In Experiment 6, samples that have a cylindrical shape having an outer diameter of 40 mm and in which the length thereof in the vertical direction (thickness h) is changed were prepared. In Experiment 6, a nanocrystallized powder having a particle size of 11 μm (median diameter D50) was used as a magnetic powder. Further, a phosphate-based glass and a phenol resin were used as the material for the binder. The volume percentage of the phosphate-based glass with respect to the volume of the magnetic powder was set to 2.5 volume % and the volume percentage of the phenol resin with respect to the volume of the magnetic powder was set to 2.5 volume %. A method similar to that in Experiment 1 was used to prepare the powder magnetic core. Further, in Experiment 6, the prepared powder magnetic core was cut into a shape that is similar to that in Experiment 1 (a toroidal shape having an outer diameter of 13 mm, an inner diameter of 8 mm, and a length of 5 mm) and the samples for measurement were prepared. Then the samples were measured using a method similar to that in Experiment 1.

As shown in Table 6, the forming time of each of the samples was changed depending on the thickness of the smallest part. That is, the forming time of the samples is made larger as the thickness h increases so that heat is transferred to the part inside the powder magnetic core where it takes the longest time for heat to be transferred and heat is transferred to the entire powder magnetic core. More specifically, the forming time was set so that heat is transferred to the intermediate part of the length of the powder magnetic core in the vertical direction (thickness h) and a sufficient amount of deformation due to softening of the magnetic powder in the entire powder magnetic core is obtained.

As shown in Table 6, in Example 6-1 in which the thickness h was 1.7 mm, Example 6-2 in which the thickness h was 2.5 mm, Example 6-3 in which the thickness h was 3.0 mm, and Example 6-4 in which the thickness h was 3.5 mm, the values of the iron loss were equal to or smaller than 2500 and the percentages of parts of the binder layer of 20 nm or smaller were equal to or smaller than 6% (not including 0%). In particular, in Example 6-1 in which the thickness h was 1.7 mm, the value of the iron loss was 860, which was very good.

On the other hand, in Comparative Example 6-1 in which the thickness h was 4.5 mm, Comparative Example 6-2 in which the thickness h was 7 mm, and Comparative Example 6-3 in which the thickness h was 14 mm, the values of the iron loss became larger than 2500 and the percentages of parts of the binder layer of 20 nm or smaller became larger than 6%.

From the above results, it can be said that the length of the powder magnetic core in the vertical direction (thickness h), which is the part inside the powder magnetic core where it takes the longest time for heat to be transferred during the hot forming of the powder magnetic core, may be equal to or smaller than 3.5 mm. That is, heat is rapidly transferred to the entire powder magnetic core during hot forming, whereby thermal decomposition of the binder resin can be suppressed and the reduction in the effect of suppressing the flow properties of the low melting glass can be prevented, and good values of the iron loss can be obtained. Further, since heat is rapidly transferred to the entire powder magnetic core, the time of the hot forming can be shortened, resulting in reduced production time and cost. While Experiment 6 has been conducted while changing the length of the powder magnetic core in the vertical direction, setting the distance between the molding dies in the direction substantially vertical to the direction in which the part inside the powder magnetic core where it takes the longest time for heat to be transferred is extended to be equal to or smaller than 3.5 mm may also be used due to a reason similar to that stated above.

TABLE 6
Experiment 6

| | | | | Powder | | | | |
|---|---|---|---|---|---|---|---|---|
| | Thickness h | | | filling | | | Percentage of | Median |
| | of powder | | | percentage of | Permea- | Iron loss | parts of binder | thickness |
| | magnetic core | | | magnetic core | bility | @1 MHz, 50 mT | layer of 20 nm | of binder |
| | (mm) | Forming time | | (vol. %) | @1 MHz | (kW/m³) | or smaller | layer (nm) |
| Example 6-1 | 1.7 | 10 | seconds | 92.9 | 115 | 860 | 0.62% | 46 |
| Example 6-2 | 2.5 | 30 | seconds | 93.1 | 120 | 1500 | 3.2% | 41 |
| Example 6-3 | 3.0 | 45 | seconds | 92.8 | 123 | 1800 | 5.2% | 36 |
| Example 6-4 | 3.5 | 1 | minute | 92.5 | 118 | 2300 | 6.0% | 35 |
| Comparative | 4.5 | 1.5 | minutes | 91.7 | 103 | 2800 | 7.5% | 31 |
| Example 6-1 | | | | | | | | |
| Comparative | 7 | 4 | minutes | 92.2 | 113 | 5200 | 8.6% | 30 |
| Example 6-2 | | | | | | | | |
| Comparative | 14 | 15 | minutes | 91.1 | 107 | 13000 | 12.2% | 29 |
| Example 6-3 | | | | | | | | |

### Experiment 7

In Experiment 7, samples whose type of the low melting glass, which is a material for the binder, is changed were prepared. In Experiment 7, a metallic glass powder having a particle size of 9 μm (median diameter D50), a first crystallization temperature (Tg) of 480 °C, and a second crystallization temperature (Tx) of 510 °C was used as a magnetic powder. A phenol resin was used as a binder resin. The volume percentage of each low melting glass to the magnetic powder was set to 2.5 volume % and the volume percentage of the phenol resin to the magnetic powder was set to 2.5 volume %. A method similar to that in Experiment 1 was used to prepare the powder magnetic core and measure the samples.

As shown in Table 7, in Example 7-1 in which a phosphate-based glass was used as a low melting glass and Example 7-2 in which a tin phosphate-based glass was used as a low melting glass, the values of the iron loss were respectively 900 and 1600 and the percentages of the binder layer of 20 nm or smaller were respectively 0.92% and 3.6%, which were good.

On the other hand, in Comparative Example 7-1 in which a bismuth oxide-based glass was used as a low melting glass, Comparative Example 7-2 in which a boro-silicate-based glass was used as a low melting glass, and Comparative Example 7-3 in which a bariumsilicate-based glass was used as a low melting glass, the values of the iron loss were larger than 2500 and the percentages of parts of the binder layer of 20 nm or smaller became larger than 6%.

TABLE 7
Experiment 7

| | | | Powder | | | | |
|---|---|---|---|---|---|---|---|
| | | Softening | filling | | | Percentage of | Median |
| | | temperature | percentage of | Permea- | Iron loss | parts of binder | thickness |
| | | of glass | magnetic core | bility | @1 MHz, 50 mT | layer of 20 nm | of binder |
| | Glass composition | (° C.) | (vol. %) | @1 MHz | (kW/m³) | or smaller | layer (nm) |
| Example 7-1 | Phosphate-based | 400 | 93.7 | 121 | 900 | 0.92% | 40 |
| Example 7-2 | Tin phosphate-based | 350 | 93.6 | 112 | 1600 | 3.6% | 31 |
| Comparative | Bismuth oxide-based | 410 | 92.6 | 117 | 3300 | 7.1% | 42 |
| Example 7-1 | | | | | | | |
| Comparative | Boro-silicate-based | 520 | 91.6 | 132 | 5300 | 8.6% | 33 |
| Example 7-2 | | | | | | | |
| Comparative | Bariumsilicate-based | 800 | 90.1 | 122 | 7100 | 9.4% | 45 |
| Example 7-3 | | | | | | | |

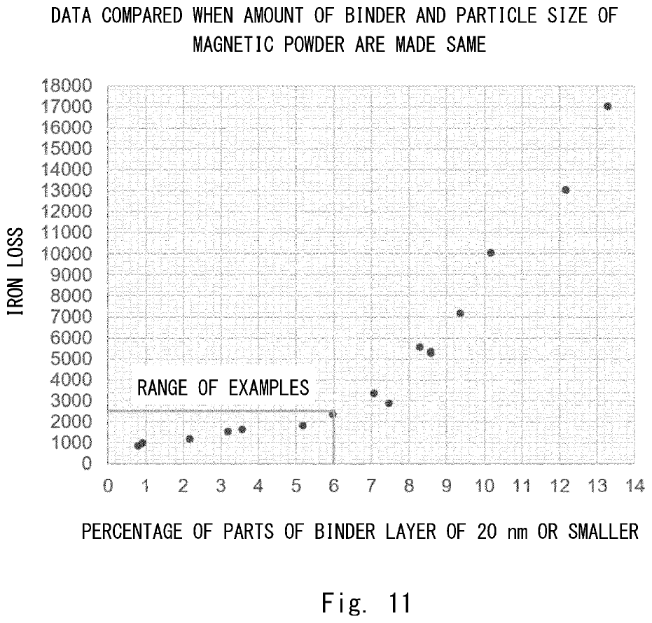

FIG. 11 is a graph in which the iron loss of the samples and the percentage of parts of the binder layer of 20 nm or smaller are plotted when the amount of the binder and the particle size of the magnetic powder are made the same in the aforementioned Experiments 1-7. In the graph shown in FIG. 11, the amount of binder of the samples is 2.5 volume % of low melting glass and 2.5 volume % of resin material with respect to the amount of the magnetic powder, and the particle size of the magnetic powder is 9 μm. As shown in the graph in FIG. 11, as the percentage of parts of the binder layer of 20 nm or smaller increases, the iron loss tends to increase. According to the present disclosure, by setting the percentage of parts of the binder layer of 20 nm or smaller to be 6% or smaller (not including 0%), the iron loss can be made 2500 or smaller, and this range is the range of Examples.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

1. A method for manufacturing a powder magnetic core comprising:
a process of coating a magnetic powder with a low melting glass;
a process of coating the magnetic powder coated with the low melting glass with a resin material for granulation; and
a process of hot forming the magnetic powder after the granulation, wherein
the formed body after the hot forming contains 88 volume % or more of magnetic powder,
a binder layer including the low melting glass and the resin material is formed between particles of the magnetic powder, and
the percentage of parts of the binder layer having thicknesses of 20 nm or smaller in the binder layer that is present between particles of the magnetic powder is set to be equal to or smaller than 6%.

2. The method for manufacturing the powder magnetic core according to claim 1, wherein
the magnetic powder is a metallic glass, and
the temperature during the hot forming is equal to or higher than one of a softening temperature of the low melting glass and a glass transition temperature of the magnetic powder which is higher than the other one but is equal to or lower than a crystallization temperature of the magnetic powder.

3. The method for manufacturing the powder magnetic core according to claim 1, wherein
the magnetic powder is a nanocrystallized powder, and
the temperature during the hot forming is equal to or higher than one of a softening temperature of the low melting glass and a first crystallization temperature of the magnetic powder which is higher than the other one but is equal to or lower than a second crystallization temperature of the magnetic powder.

4. The method for manufacturing the powder magnetic core according to claim 1, wherein the total amount of the low melting glass and the resin material with respect to the amount of the magnetic powder is smaller than 10 volume %.

5. The method for manufacturing the powder magnetic core according to claim 4, wherein a volume percentage of the low melting glass included in the magnetic powder after the granulation with respect to the volume of the magnetic powder is equal to or larger than 0.5 volume % but equal to or smaller than 6 volume %.

6. The method for manufacturing the powder magnetic core according to claim 4, wherein a volume percentage of the resin material included in the magnetic powder after the granulation with respect to the volume of the magnetic powder is equal to or larger than 0.5 volume % but equal to or smaller than 9 volume %.

7. The method for manufacturing the powder magnetic core according to claim 1, wherein the low melting glass is a phosphate-based or a tin phosphate-based glass.

8. The method for manufacturing the powder magnetic core according to claim 1, wherein the resin material is at least one type of resin material selected from the group consisting of a phenol resin, a polyimide resin, an epoxy resin, and an acrylic resin.
